(19) United States
(12) Patent Application Publication
(10) Pub. No.: US 2014/0289012 A1
(43) Pub. Date: Sep. 25, 2014

(54) AGGREGATED SENSORY PROFILE GENERATION, ANALYTICS, AND INSIGHTS

(71) Applicant: ENTERRA SOLUTIONS, LLC, Newtown, PA (US)

(72) Inventors: Stephen F. DeAngelis, Washington Crossing, PA (US); Jason Glazier, Newtown, PA (US); Steven Sermarini, Schwenksville, PA (US)

(73) Assignee: Enterra Solutions, LLC, Newtown, PA (US)

(21) Appl. No.: 13/847,273

(22) Filed: Mar. 19, 2013

(51) Int. Cl. G06Q 10/06

(52) U.S. Cl. CPC G06Q 10/063
USPC 705/7.32; 705/14.66

(57) ABSTRACT

Computer-based systems and methods for determining an aggregate sensory profile for a plurality of individuals. The system may comprise a plurality of remote computer systems, each comprising: a local database for storing user data about the plurality of individuals; and a local sensory profile determination engine for generating sensory profile data for each of the plurality of individuals based on user data stored in the local database. The system may also comprise a central computer system that receives the sensory profile data from the plurality of remote computer systems. The central computer system comprises: a central database for storing the sensory profile data received from the remote computer systems; and a sensory profile aggregation engine for generating aggregate sensory profiles for each of the plurality of individuals based on the sensory profile data received from the remote computer systems and stored in the central database.

### BACKGROUND

Systems for generating visual profiles for a person's or a food's flavor profile are known. One such system is McCormick & Company, Inc.'s FlavorPrint® flavor advisement system. The FlavorPrint® flavor advisement system provides a visual display, sometimes referred to as a “flavor mark,” that indicates a person's flavor sensory impression for a number of different flavor characteristic categories. In particular, the FlavorPrint® flavor advisement system as of the date of this application uses thirty-three different flavor characteristic categories, and a number of texture categories (which are not currently shown on the flavor mark). The person's flavor profile is represented with a hub-and-spoke display, where each spoke corresponds to one of the 33 flavor characteristic categories, with the length of the spoke corresponding to the user's preference for the corresponding flavor characteristic category, as shown in the example of FIG. 1. The spokes may be represented by different colors, and when displayed on a web site, such as www.mccormick.com/FlavorPrint/Dashboard, the user can hover his/her cursor over the individual spokes to see more information about the flavor characteristic category associated with the spoke. The particular example flavor mark of FIG. 1 represents a preference for cheesy (spoke 1), coffee/chocalatey (spoke 2), and salty (spoke 3) flavors.

Foods or recipes could also be represented by flavor marks. For example, FIG. 2 shows an example flavor mark for a chicken pot pie recipe, with the dominant spoke 4 corresponding to garlic/onionish flavor. In this example, the number of flavor characteristics is limited to the top 9.

A person's flavor mark may be determined based on inputs (such as survey inputs) from the person about their food and flavor preferences, combined with knowledge about the flavor and texture characteristics of the foods and flavors. Similarly, a food or recipe's flavor mark may be determined based on knowledge about the flavors, textures, and/or cooking methods associated with the food or recipe. Utilizing this information, a user could then look for foods and recipes with flavor marks that compliment their personal flavor mark, or foods and recipes could be recommended for the user.

A person's flavor mark visual display is based on the user's flavor and food texture preferences across a number of flavor and food texture categories (such as the 33 flavor categories and texture categories currently used in the McCormick & Company, Inc.'s FlavorPrint® flavor advisement system). The flavor mark for an individual (or a recipe) is based on the individual's (or the recipe's) score in each of the flavor and texture categories, sometimes referred to herein as “attributes,” and those scores make up what is referred to herein as a “flavor profile.”

### SUMMARY

Sensory profiles, such as flavor profiles, that are determined based on user surveys can be considered “active” profiles. A disadvantage of active flavor profiles is that user effort is required to generate the flavor profile, such as the user responding to survey questions about food, flavor and/or texture preferences. In one general aspect, the present invention is directed to systems and methods for aggregating a person's active and passive sensory (e.g., flavor) profiles across multiple data sources. A person's passive sensory (e.g., flavor) profile may be determined from passive information about the person that is suggestive or indicative of the person's preferences, e.g., food and flavor preferences, without the person having to provide explicit inputs about their preferences. For example, the passive information may include a person's clickstream data from food-related websites, such as recipe websites and/or websites of food retailers (e.g., grocery stores) or food and food-related suppliers (e.g., manufacturers of food and food-related items). In addition, inferences about the flavor and texture preferences of a user may be drawn based on the recipes that a person views on a website. Also, passive information may also include, for example, loyalty program or other available purchasing data for the user because similarly, based on the food items that a user purchases, flavor preferences of the user may be inferred.

The systems and methods of the present invention aggregate a person's active and/or passive sensory (e.g., flavor) profiles, across multiple data sources. This has the advantage that when a person's flavor profile is based on a single data source (e.g., data from a single web site or single loyalty program), the result might be a limited view of the person's true flavor preferences, whereas aggregating the person's flavor profile across multiple data sources is more likely to provide a more complete and accurate portrait of the person's flavor preferences. One obstacle to generating such aggregate flavor profiles, however, is that the data sources are unlikely to provide their underlying user base individual consumer data for privacy, competitive, and/or other reasons. For example, a recipe website is unlikely to externally provide its clickstream data and/or its user survey data. Similarly, a loyalty program is unlikely to externally provide the purchasing data of its users. To overcome these obstacles, in one embodiment, a local flavor profile determination engine is used at each data source. The local flavor profile determination engine determines the users' flavor profiles based on the data available from the data source. This can be done behind the data sources' firewalls, so that the underlying data is not transmitted externally beyond the data sources and is secured from the computer system that generates the aggregate flavor profiles. The local flavor profile data for each data source, e.g., the score for each flavor and texture characteristic category (e.g., attribute) available from each data source, may then be transmitted (via an electronic data communications network, such as the Internet) to a flavor profile aggregation engine, which aggregates the attribute scores from the various data sources to generate a composite or aggregate flavor profile that is more likely to provide an accurate, complete, holistic description of a person's flavor preferences since it is determined based on data from multiple, disparate data sources. Such a configuration has the advantage that less data is sent externally beyond the data sources. Instead of sending all of the user's clickstream data externally, or all of the user's purchasing data externally, or all of the user's survey response data to compute the user's aggregated flavor profile, just the user's, greatly compressed, flavor profile data (e.g., the user's scores/values for each of the various flavor and texture attributes) needs to be transmitted externally (along with appropriate identifying and header information) and only if the user's local flavor profile has changed, which should become less frequent over time.

Moreover, in another general aspect, various sensory-based analytics/insights may be performed with the aggregated flavor profiles. For example, the flavor profiles for users in a particular geographic region (e.g., zip code area) could be combined to generate a composite flavor profile for the geographic area. Such composite flavor profile information may be used for product development/innovation, product marketing and/or supply chain management, amongst other functions. Also, a person's aggregated flavor profile and/or a geographic region's composite flavor profile may be used for targeted online advertising.

These, and other benefits of the present invention, will be apparent from the description that follows.

### FIGURES

Various embodiments of the present invention are described herein by way of example in conjunction with the following figures, wherein:

FIG. 1 illustrates a flavor mark for an individual;

FIG. 2 illustrates a flavor mark for a recipe;

FIG. 3 is a block diagram of a system for generating aggregate flavor profiles for individuals according to various embodiments of the present invention;

FIGS. 4 and 5 illustrate examples of geographic region composite aggregate flavor profiles according to various embodiments of the present invention;

FIG. 6 is a diagram of a process flow for performing analytics/insights on the geographic region composite aggregate flavor profiles according to various embodiments of the present invention; and

FIG. 7 is a block diagram of a targeted advertisement system according to various embodiments of the present invention.

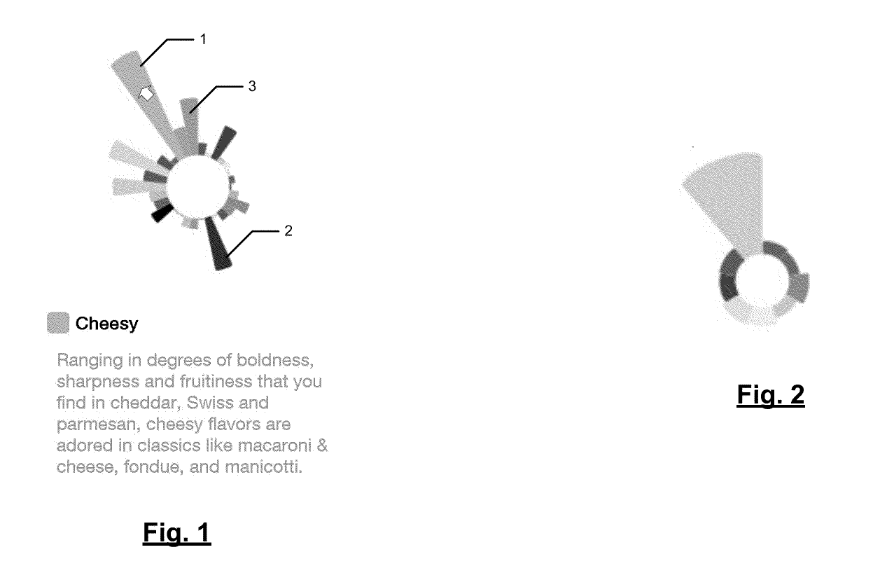

### DESCRIPTION

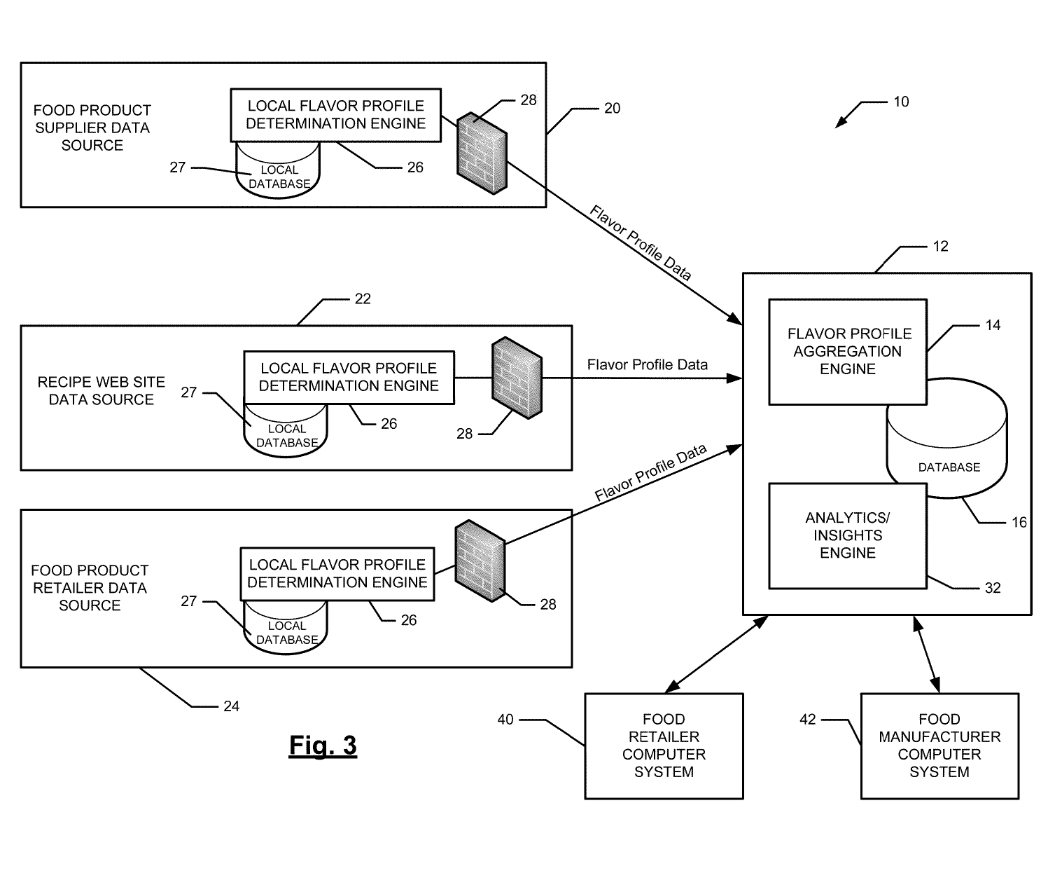

FIG. 3 is a simplified block diagram of a system 10 for generating aggregated sensory (e.g., flavor) profiles for different individuals according to various embodiments of the present invention. As shown in the example of FIG. 3, the system 10 may include computer system 12 that computes or generates the aggregated sensory (e.g., flavor) profiles for the various individuals. The computer system 12 may include a sensory profile aggregation engine, in this case a flavor profile aggregation engine 14, and an associated computer database 16. The computer system 12 may be implemented with any suitable computing device that has a programmable processor(s) and associated computer memory, such as server, personal computer, mainframe, etc., or a collection (“network”) of such computing devices. The flavor profile aggregation engine 14 may include the processor(s) and memory unit(s) of the computer system 12, where the memory unit(s) store computer instructions (e.g., software) to be executed by the processor(s) to compute the aggregated flavor profiles, as described herein. The database 16 may store the aggregated flavor profiles for the various individuals, which data may be stored in a non-volatile computer memory, such as a hard disk drive, read-only memory, or other types of non-volatile computer memory. The database 16 may also store the local flavor profile data (e.g., flavor and texture attribute scores) received from the various data sources 20, 22, 24, described further below, that are used to generate the aggregate flavor profiles. In the description to follow, “flavor” is used without “texture,” but it should be understood that when used generally “flavor” includes food-related texture as well as olfactory responses that affect flavor.

The flavor profile aggregation engine 14 may generate the aggregated flavor profiles from data across multiple data sources. The data sources across which the aggregated flavor profiles are computed may be any computer system data source with reliable data that is directly or indirectly indicative of a person's food and flavor (or other sensory) preferences. Such data sources may include, for example, without limitation, data from food and food product manufacturers, data from recipe websites, and purchasing data from loyalty programs that track an individual's purchases. In the example of FIG. 3, one of each of those data sources is shown, although the invention is not so limited and preferably as many reliable data sources as possible are used to obtain a more complete and accurate determination of an individual's flavor profile.

In particular, the example of FIG. 3 shows a food product supplier data source 20, a recipe web site data source 22, and loyalty program data source 24. Each data source 20, 22, 24 may have a local flavor profile determination engine 26 that determines the flavor profiles for individuals based on the intrinsic user data for the individuals stored in its associated data source 27. As such, the local flavor profile determination engines 26 may compute their intrinsic flavor profiles for various individuals behind the firewalls 28 associated with the respective data sources 20, 22, 24. The data sources 20, 22, 24 may then transmit their intrinsic flavor profile data for the individuals to the computer system 12 so that the flavor profile aggregation engine 14 can compute an aggregated flavor profile for the individuals across all of the data sources 20, 22, 24, which should provide a more complete, accurate portrayal of the individual's true flavor profile since it is based on multiple, disparate data sources. The flavor profile data received from the various data sources may be stored in the database 16, as mentioned above.

Also as mentioned above, the local flavor profiles (computed at the data sources 20, 22, 24) may be computed based on user data intrinsic to the local data source. In the case of a food or food product manufacturer (e.g., data source 20 in FIG. 3), that data may include survey, purchasing and/or clickstream data about an individual. For example, at the web site for the food or food product (sometimes collectively referred to herein as “foodstuff”) manufacturer, the individual may take a survey about food, flavor, texture and/or cooking method preferences of the individual. Also, the web site for the food or food product manufacturer may track online purchases made by the individual through the web site. Still further, if the web site offers information about food items or recipes, the web site could track the specific webpages on the web site that an individual visits (e.g., clickstream data). The websites may be tracked based on the individual's IP address and/or the individual's user ID entered when logging into the web site. All of these types of data could be used to generate a local flavor profile for the individual based on the food or food product manufacturer's data. The survey data (if available) clearly shows the individual's food and flavor preferences. The purchasing data provides indirect insight into the individual's food and flavor preferences; presumably people buy the foods with the flavors that they prefer. Similarly, the clickstream data provides indirect insight into the individual's food and flavor preferences. If an individual reads about a particular foodstuff it may be assumed that the individual has some preference for the flavors associated with that foodstuff. Similarly, inferences about an individual's flavor preferences can be made based on recipes that the individual reviews online. The data source 20 may have its preferred manner of weighting each of these data types in its computation of its local flavor profiles.

The recipe web site 22 may have clickstream data about the webpages that an individual (associated with an IP address and/or user ID entered at site log in) visited while at the recipe web site, and actions such as time spent viewing a recipe, saving, or printing recipes that show enhanced interest. As explained above, the clickstream data for the recipe web site may show which recipes and foodstuff-related articles the individual viewed online. The recipe web site 22 may draw inferences about an individual's flavor preferences from this data, and the local flavor profile determination engine 26 of the recipe web site data source 22 may compute the individuals' flavor profiles based on the data intrinsic to the recipe web site 22, which may, as explained above, be transmitted to the computer system 12 for computation of the individuals' aggregate flavor profiles.

The loyalty program data source 24 may have loyalty or purchasing data for an individual. For example, the loyalty program data source 24 may be associated with a grocery store or other retail food store whose customers have loyalty cards. After check out, the retailer transmits (usually in batch) to the data source 24 the individuals' purchasing data, including the items purchased and date of purchase, etc., which data is indexed to the individual's loyalty program user ID for the individual. Inferences about the users' flavor preferences may be drawn from such purchasing data, and the local flavor profile determination engine 26 may compute the flavor profiles for the loyalty program members based on this intrinsic purchasing data. Also, if the loyalty program has survey or clickstream data about, or otherwise indicative of, flavor or food preferences, this data may also be used by the local flavor profile determination engine 26 of the loyalty program data source 24 to compute the members' flavor profiles. Again, the members' flavor profile data may be transmitted to the computer system 12 for computation of the individuals' aggregate flavor profile.

In computing the local flavor profiles, all attributes may be assumed to be independent so the inter-combination of attribute scores should be considered for each attribute separately (e.g., perform one inter-combination for each of the attributes). Various methodologies may be used by the local flavor profile determination engines 26 to compute the local flavor profiles for the individuals in their data sets. One methodology that could be used is a “percentile” technique where, assuming the user likes many foods, each attribute's score is sorted separately, and the percent value for each attribute is set to be that attribute's score. For example, if the 80% value was decided to be used as the percentile for a given attribute (e.g., salty), the 160^{th} highest value (assuming 200 different foods) as the given attribute's score (or value). Preferably, all the local flavor profile determination engines 26 use the same percentile for a given attribute (e.g., salty), but not all attributes need to have the same percentile. For example, 70% could be used for sweet and 80% could be used for salty. The percentile methodology is useful so that the attributes' values are not overly influenced by a small number of outliers.

Another methodology is a so-called “maximum” methodology, which is the same as 100% percentile. Under this methodology, again assuming that a user likes many foods, is to score the highest value score for each attribute, across all liked foods, for that attribute. For example, if out of 200 foods, the most salty food the user liked was scored a 10 out of 15, that user's personal salty attribute score is set to 10.

Another methodology is to set the mean value for each attribute to that attribute's score. For example, again assuming the individual liked 200 foods, the individual's salty attribute would be the mean of the salty attribute score across those 200 liked foods.

A variation on these methodologies is to ignore attribute scores above or below a threshold value, under certain conditions. For example, attribute scores below a certain value could be ignored, in which case the percentile or mean method would only use a subset of the attribute's values. This technique can be used to filter out attribute values where the attribute's contribution is minimal and not a significant driver of preference. Similarly, attribute scores above a maximum threshold could be ignored under certain conditions.

The local flavor profile determination engines 26 of the data sources 20, 22, 24 preferably all use the same attributes and the same scoring scale. If the same scales are not used, the flavor profile aggregation engine 14 may scale the attribute scores that it receives accordingly so that they are scored on the same scale. The local flavor profile determination engines 26 could all use the same methodology to compute their local flavor profile or they could use different methodologies. The methodology of McCormick & Company, Inc.'s FlavorPrint® flavor advisement system can be found in U.S. patent application Ser. No. 13/775,791, filed Feb. 25, 2013, which is incorporated herein by reference in its entirety. The individuals' local flavor profile data (e.g. the attribute scores), e.g., changes for existing individuals or complete flavor profile data for new individuals, are transmitted (along with an identifier for the individual and/or other appropriate identifying information) from the data sources 20, 22, 24 to the computer system 12, via an electronic data communications network such as the Internet (not show), using suitable APIs, for example, for computation of the aggregate flavor profiles. Transmitting such limited, greatly compressed data sets is preferable over transmitting all of the underlying user data from which the local flavor profiles are determined for several reasons, including (1) less data is transmitted, which saves network resources, and (2) it ameliorates privacy concerns of the individuals.

The flavor profile aggregation engine 14 may merge the local flavor profile data it receives from the various data sources 20, 22, 24 based on user IDs to create an aggregate, holistic flavor profile for each individual for which it receives data. It may use any suitable technique to merge, or inter-combine, the local flavor profile data. In one embodiment, it may use a specified percentile score for an attribute to be the individual's aggregate score for that attribute. For example, if scores from twenty data sources are received, and the specified percentile is 80% for a particular attribute, the individual's 16^{th} highest score for that attribute is used as the individual's aggregate score for that attribute. The different attributes could use the same or different percentiles. If the 100% percentile is used, the individual's highest scores are used as the aggregate attribute scores. For example, on a scale of 1 to 15, if Data Source 1 has an individual's salty attribute score as 8, and Data Source 2 has an individual's salty attribute score as 7, and Data Source 3 has an individual's salty attribute score as 5, in the 100% percentile (or maximum) embodiment, the flavor profile aggregation engine 14 uses the maximum score, in this case the score of 8 from Data Source 1, for the individual's salty attribute score. Another merging technique is to use the mean score. Using the above example and mean scores, the individual's aggregate salty attribute score would be 6.67 (the mean of 8, 7 and 5). Also, in any of these techniques, according to various embodiments, attribute scores above or below a threshold value are not used.

Also, in various embodiments, the flavor profile aggregation engine 14 may weigh the local flavor profile data from the data sources 20, 22, 24 differently when computing the aggregate flavor profile for an individual. For example, data sources known to have more reliable data could be weighted higher. Also, along with the attribute scores for the individual's, the data sources 20, 22, 24 may transmit statistics related to the size of the data set for the individual. For example, a recipe web site may send statistics on the number of sites viewed by each individual, or a loyalty program data source may send statistics on the number of items purchased by each individual. These data set size statistics could be used to weight the local flavor profile data from the data sources 20, 22, 24 when computing the aggregate data profile.

In addition, combinations of these merging techniques could be used. For example, in one embodiment, if less than N data sources report a value for a particular attribute for an individual, one technique (e.g., the mean technique) may be used to compute the aggregate score for that attribute; otherwise a different technique (a percentile score) is used to compute the aggregate score for the attribute.

As shown in FIG. 3, the computer system 12 may also comprise an analytics/insights engine 32 that performs analytics/insights on the aggregate flavor profiles stored in the database 16. The analytics/insights engine 16 may be implemented with the processor(s) and computer memory unit(s) of the computer system 12, with the processor(s) executing software stored in the computer memory unit(s) to perform the analytics/insights as programmed by the software. In one embodiment, the analytics/insights engine 32 may create a geographic region composite flavor profile by merging aggregate flavor profiles for individuals within a specific geographic region. The analytics/insights engine 32 could generate geographic region composite flavor profiles for multiple different geographic regions. The geographic regions may be, for example, postal/zip codes. In such an embodiment, the analytics/insights engine 32 may create a postal/zip code composite flavor profile for a particular postal/zip code by aggregating the aggregate flavor profile data of individuals from that particular postal/zip code; the analytics/insights engine 32 may do this for each postal/zip code for which it has aggregate flavor profile data. In other embodiments, different geographic regions could be used, such as telephone area codes, school districts, geographic areas based on connection to a network router topologies, mobile cellular tower connection, GPS determined locations, etc.

In various embodiments, individuals might register with the computer system 12 (such as via a web site) to gain the benefit of their aggregated flavor profiles, such as targeted advertising, loyalty program reward points, special offers, etc. The registration procedure may require the individuals to enter demographic information about themselves, including where they live, so that the geographic region composite may be generated, as well as other demographic information, such as age, income, ethnicity, education level, etc. The registration procedure may also solicit approval from the individuals for the data sources 20, 22, 24 to transmit their local flavor profiles for the individuals to the computer system 12. Still further, the registration web site may provide a survey through which the users provide responses to survey questions that directly or indirectly indicate their food and/or flavor preferences. In addition, the web site may also allow the users to input explicit information or constraints about their food and/or flavor preferences, and even supply chain (delivery) preferences. This data may be stored in the database 16 and used by the analytics/insights engine 32.

Several different aggregations of the geographic region flavor profiles may be useful. In one embodiment, the analytics/insights engine 32 may generate a distribution chart, such as shown in FIG. 4. Such a distribution table may be for one geographic region; separate distribution tables may be generated for other geographic regions. One dimension of the table (the horizontal dimension in the example of FIG. 4) may span the range of attribute scores—1 to 15 in this example. A second dimension of the table (the vertical dimension in the example of FIG. 4) may span the different attributes that are tracked in the flavor profiles; in this example there are 50 attributes. The cells of the table may be populated, for example, with the number of individuals from the geographic region (for which there is an individual aggregate flavor profile) that had the attribute score corresponding to the cell for the attribute corresponding to the cell. Also, instead of the number of individuals, the cells could indicate the relative percentage of overall individuals that have the attribute score corresponding to the cell for each attribute (e.g., the sum of percentages across the scoring range for each attribute should be 100%). In an analysis such as this, a less granular range may be preferred, such as one in which scores of 1 to 4 are grouped together as “low,” scores of 5 to 7 are group together as “medium,” scores of 8 to 11 are grouped together as “high,” and scores of 12 to 15 are grouped together as “very high,” as one example.

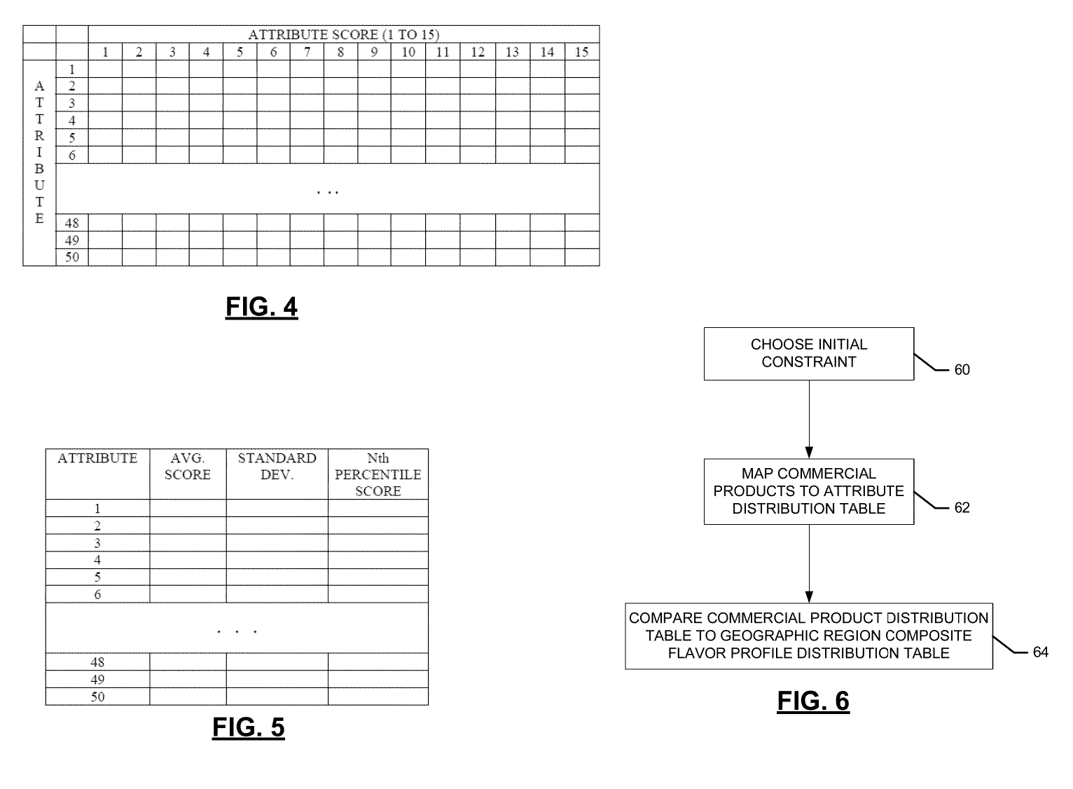

Additionally or alternatively, the analytics/insights engine 32 computes an average score for each attribute across the individuals from the geographic region, as shown in the example of FIG. 5. The analytics/insights engine 32 may also compute other statistical measures related to, for example, the dispersion of the attribute scores, such as the standard deviation and/or some other suitable dispersion statistic. In another embodiment (additionally or alternatively), the analytics/insights engine 32 computes the score that is the Nth percentile (e.g., 75^{th} percentile) for the individuals in the geographic region for each attribute, also as shown in the example of FIG. 5. Again, in these examples, individuals whose scores for an attribute are above, and/or more likely below, a threshold value can be ignored under certain conditions.

The geographic region composite flavor profiles may be stored in the database 16. Further, food retailers 40 (e.g., grocery stores) may access the geographic region composite flavor profiles (via an API, for example) in order to perform product inventory and/or product assortment analytics/insights. For example, a food retailer may compare the inventory of a store in a particular geographic region to the composite flavor profile for that geographic region (determined by the analytics/insights engine 32 and stored in the database 16) to assess whether the store's inventory is appropriate for the flavor profile of the geographic region. Such analysis may identify inventory adjustments that need to be made to presently stocked items as well as new items that should be offered at the store location (and potentially items that should no longer be carried). In addition to inventory adjustments, such analysis may identify potential changes for shelf and/or display location allocations in the store (often measured in terms of square feet, number of products, linear feet, display capacity, stacking height, etc.). For example, a food product that better matches the flavor preferences of the geographic region may be moved to an end aisle display or to an otherwise more prominent shelf or display location in the store. Conversely, products that do not match the local flavor profile may have their shelf space reduced and/or moved to a less prime store placement based on the analysis of the composite flavor profile for the geographic region.

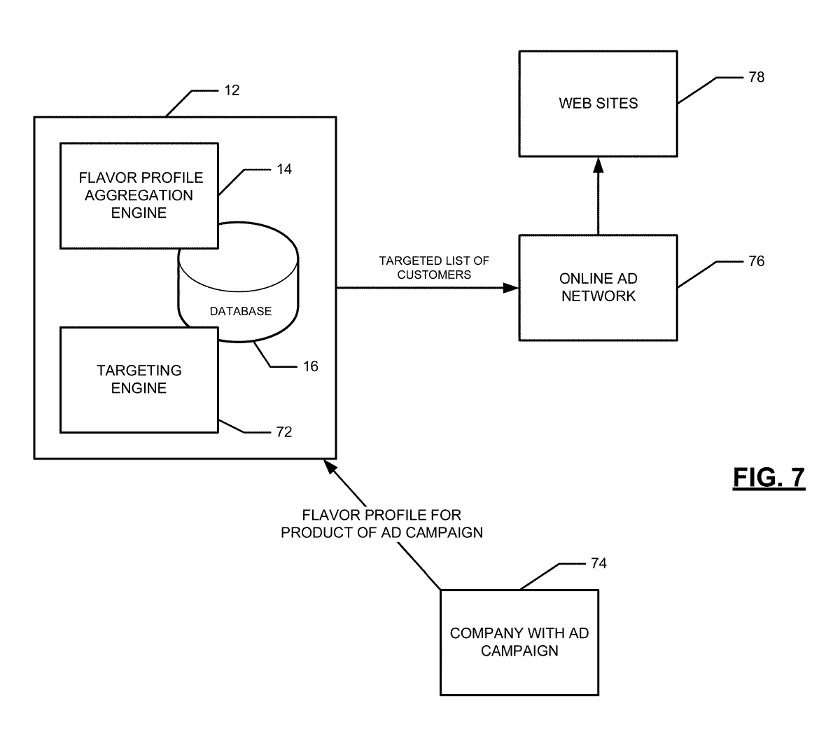

The analytics/insights engine 32 (or other computer system accessing the composite flavor profiles stored in the database 16, such as the food retailer computer system 40) may also be programmed in various embodiments to analyze the geographic region composite flavor profiles to discover unaddressed flavor needs in a geographic region. FIG. 6 is a flow chart of a process, performed by an appropriately programmed computer system (e.g. the analytics/insights engine 32 or the food retailer computer system 40), for performing such an analysis. The process starts at step 60, where an initial constraint is chosen, such as a combination of product category and target demographic; for example, condiments (or a more granular product category, such as mustard) for a particular geographic region. At step 62, each commercial product that fits that product category is mapped into a distribution table, similar to the one shown in FIG. 4, but now with the cells showing the number (or percentage) of commercial products have the attribute/value pair associated with the cell. The example of FIG. 4 uses a range of 1-15 for the attribute scores. In an analysis such as this, a less granular range may be preferred, such as 1-3 (low, medium, high) or some other suitable range. Next, at step 64, the product distribution table (generated at step 62) is compared to, or overlaid with, the distribution table for the geographic region (see FIG. 4). Such a comparison may identify gaps in flavor and texture preferences between the product offering and the preferences of the community. For example, if a significant portion of the community likes spicy food and the product offering has very few products that are spicy, this may be product gap that can be addressed by a new product.

The geographic region composite flavor profiles may also be used for new product development or product modification. In such an embodiment, a food manufacturer computer system 42 may be in communication with the computer system 12 (such as via an API) to access the composite flavor profiles stored in the database 16. Within new product development, when a food manufacturer is considering developing a product, or has a product already developed, it can simulate how that product addresses the taste preferences of their targeted consumers by comparing the flavor attributes of the product to the composite flavor profiles of a geographic region (or a composite of several geographic regions). If the food manufacturer is not satisfied with the way the product is addressing the consumer preferences of their target consumers, the analytic/insight study can help them adjust the taste profile of their product by determining the areas of the taste profile that can be modified to better address their targeted consumers' preferences. One implementation embodiment would be to compare the attribute distances of a representative flavor profile derived from the consumer targets (e.g., the composite flavor profiles stored in the database 16) to the flavor profile of the product. The attribute distances may be calculated (by, for example, the analytics/insights engine 32 of the food manufacture computer system 42) and distances greater than a threshold (e.g., gaps in the flavor attributes of the product compared to the target consumers) may be determined and displayed to the user. Also, the geographic region composite flavor profiles may assist a food manufacture and/or food retailer to determine in which geographic regions to launch a new product, as it is often desirable to launch a new product in a location that is more likely to favorably accept a product's taste and thereby increase its market penetration. The geographic region composite flavor profiles may also assist a food manufacturer and/or food retailer to determine new geographic markets to target for expansion.

In other embodiments, additionally or alternatively, the analytics/insight module 32 may generate composite flavor profiles based on other demographics besides geographic region. For example, the analytics/insight module 32 may generate composite flavor profiles based on, in addition to geographic region, income, ethnicity, age, and/or education level, or any other suitable demographic data, to the extent such demographic data about the users is available and such composites are beneficial.

In other embodiments, the individual's aggregate flavor profiles may be used for online, targeted advertising through an online ad network. FIG. 7 is a block diagram that illustrates the data flow according to one such embodiment. Suppose a company 74 has a food-related product that it wants to market with an online ad campaign. In the example of FIG. 7, the company 74 transmits (via a computer network, for example, such as the Internet) a flavor profile for the product to the computer system 12. In various embodiments, the computer system 12 may also have, or have access to, a data store of target for the advertisements, such as the ad network's data store of audience members for the advertisement campaign. The ad network audience member data may be stored in the database 16 or some other database.

In various embodiments, the computer system 12 has a targeting engine 72 (e.g., one or more processors programmed with software, stored in memory, to perform the ad targeting functions described below). The targeting engine 72 creates a target list of individuals for whom the product should be targeted. The targeting engine 72 may do this by, for members of the ad network target audience, comparing the flavor profile for the product (received from the company 74) to the aggregate flavor profiles stored in the database 16 to find compatible matches between the flavor profile of the product and the aggregate flavor profiles of the individuals that indicate individuals who might be attracted to or otherwise have a preference for the product that is the subject of the ad campaign. The targeted list of individuals may then be sent to the online ad network 76. The ad network 76 may control the ad space on various web sites 78 that host online ads. When a targeted individual is detected on one of the web sites 78, such as by the individual's browser cookie data, IP address or user ID, the ad network delivers the ad material to the web site 78 for display to the individual on a web page hosted by the web site 78. The ad network may utilize an ad service agency, which is not shown in FIG. 7 for the sake of simplicity, to serve the ads to the web sites 78.

In various implementations, the company 74 may pay for placement of the online advertisements. In various embodiments, the company 74 may pay the computer system 12 (or the administrator thereof), with a portion of the payment distributed to each of the data sources 20, 22, 24 (see FIG. 3) as compensation for sharing their local flavor profile data with the computer system 12. The payment to the data sources 20, 22, 24 need not be equal; e.g., data sources with richer data may be paid more. The ad network 76 pays the web sites 78 for placement of the online ads. In variations using an ad service agency, the ad network 76 may pay the ad service agency and the ad service agency may then pay the web sites 78. The computer system 12 (or the administrator thereof) is paid, with proceeds from the payment by the company 74, for generating the targets. Also, the ad network 78 is paid with proceeds from the company 74 pursuing the ad campaign. Because the ads are targeted, e.g., targets are selected based on their flavor profile match to the advertised product's flavor profile, they should command greater prices than untargeted advertising.

Returning to FIG. 3, in various embodiments the analytics/insights engine 32 may also employ marketing mix modeling (MMM). MMM is an analytical approach that uses historic information, such as syndicated point-of-sale data and companies' internal data, to quantify the sales impact of various marketing activities. Mathematically, this is done by establishing a simultaneous relation of various marketing activities with the sales, in the form of a linear or a non-linear equation, through the statistical technique of regression. MMM defines the effectiveness of each of the marketing elements in terms of its contribution to sales volume, effectiveness (volume generated by each unit of effort), efficiency (sales volume generated divided by cost) and ROI. These learnings are then adopted to adjust marketing tactics and strategies, optimize the marketing plan and also to forecast sales while simulating various scenarios. This is accomplished by setting up a model with the sales volume/value as the dependent variable and independent variables created out of the various marketing efforts. Once the variables are created, multiple iterations are carried out to create a model which explains the volume/value trends well. Further validations are carried out, either by using a validation data, or by the consistency of the business results. The output can be used to analyze the impact of the marketing elements on various dimensions. If detailed spend information per marketing activity is available then it is possible to calculate the return on investment of the marketing activity. Not only is this useful for reporting the historical effectiveness of the activity, it also helps in optimizing the marketing budget by identifying the most and least efficient marketing activities. Once the final model is ready, the results from it can be used to simulate marketing scenarios for a “what-if” analysis. This analysis can be used to reallocate a marketing budget in different proportions and see the direct impact on sales/value. The budget can be optimized by allocating spends to those activities which give the highest return on investment.

In various embodiments, the analytics/insights engine 32 uses a MMM algorithm to determine an allocation between, for example, marketing spend to online advertising versus print or general branding for a target population. Online and print advertising is commonly delivered as a targeted advertisement and is often paired with a coupon or temporary price reduction (jointly referred to as “discounting”), all of which reduces the profit margin of the manufacturer and/or retailer for the sales resulting out of the use of that campaign. The computer system 12 brings a novel input into the MMM process where sensorial based information, e.g., the aggregate and/composite flavor profiles described above, is used to help inform the MMM process. Some examples of possible sensorial-based MMM insights that are not possible without sensorial-based taste preference include:
When a target population (which may be a sub-set of the overall target population) fundamentally likes a product's flavor (e.g., the match between the composite flavor profile for the population is close to the flavor profile of the food(s) that are being advertised), then perhaps just advertising the product may be enough to more efficiently drive sales without the needed to further discount.
When a target population (which may be a sub-set of the overall target population) fundamentally likes a product's flavor, there may be no need to recommend the product, and a better use of the advertising money may be to target a different product (i.e., they like the product anyway and already buy it regularly, so there will be very little sales lift from continuing to advertising the product to this population).
When a product's flavor of a target population (which may be a sub-set of the overall target population) is not a close match to their current flavor preferences, more of a discounting may be necessary to entice them to try to new flavor embodied within the product and/or recipe used to compliment the product.
When a product's flavor of a target population (which may be a sub-set of the overall target population) is not a close match to their current flavor preferences, it may be more financially efficient to exclude this sub-population from the overall target population; or alternatively, choose another product to market to this target sub-population. In other words, this sub-population group is simply not going to buy this product, so even with an excessive marketing spend, it will be unlikely to result in a sales lift.

This may be technically accomplished, according to various embodiments, in a similar way to the ad targeting described above. A composite flavor profile is created for the target population and that composite flavor profile is then compared to the food that is to be marketed as part of the campaign (or in the case of multiple foods, the composite flavor profile of the foods). The distance from the flavor profile of the marketed food(s) to the composite population flavor profile determines the degree of match, which is assumed to be a measure of the population liking the food(s).

The various embodiments described above describe the embodiments in terms of flavor profiles for “individuals” or “users” or “consumers.” It should be noted that some of the data from which the individual flavor profile is computed is for a group of users, such as household. For example, a person belonging to a household typically does not purchase food items for themselves alone, but instead purchases food for the other members of their household. For that reason, the purchasing/loyalty data may be for a household or other group, as opposed to a single individual. Similarly, multiple users may use a single computer in a household and therefore the IP address for the computer may not identify an individual user exclusively. As such, “individual” flavor profiles described herein encompass flavor profiles for a group of users, such as a household.

In one general aspect, therefore, the present invention is directed to computer-based systems and methods for determining an aggregate sensory profile for a plurality of individuals. The system may comprise a plurality of remote computer systems (e.g., data sources 20, 22, 24). Each remote computer system may comprise: a local database (e.g., local databases 27) for storing user data about the plurality of individuals; and a local sensory profile determination engine (e.g., local flavor profile determine engines 26) for generating sensory profile data for each of the plurality of individuals based on user data stored in the local database. The sensory profile data may comprise a value (e.g., 1 to 15 or some other range of value) for each of a plurality of sensory categories (e.g., flavor and texture categories, such as those used in McCormick & Company, Inc.'s FlavorPrint® flavor advisement system). The system may also comprise a central computer system (e.g., computer system 12) in communication with the plurality of remote computer systems via a data communication network (e.g., the Internet or some other packet-switched, TCP/IP network). The central computer system receives the sensory profile data from the plurality of remote computer systems. Also, the central computer system comprises: a central database (e.g., database 16) for storing the sensory profile data received from the remote computer systems; and a sensory profile aggregation engine (e.g., flavor profile aggregation engine 14) for generating aggregate sensory profiles for each of the plurality of individuals based on the sensory profile data received from the remote computer systems and stored in the central database.

In various implementation, the user data stored in the local database of the plurality of remote computer systems is secured from the central computer system; (e.g., it is behind the firewall 28 of the remote computer systems). The sensory profile may comprise a flavor profile; as such, the plurality of sensory categories may comprise one or more flavor categories and one or more food texture categories. In addition, the user data stored by the remote computer systems may comprise, for example, clickstream data, purchasing/loyalty program data, and/or survey data. The central computer system may also comprise an analytics/insights engine programmed to analyze the aggregate sensory profiles. For example, the analytics/insights engine may be programmed to generate a composite sensory profile for a geographic region based on the aggregate sensory profiles by combining aggregate sensory profiles for individuals from the geographic region. For example, the composite sensory profile for a geographic region comprises a table, such as shown in FIG. 4, where numerical values in cells of the table are indicative of a percentage of individuals in the geographic region that a value-attribute pair corresponding to the cell of the table.

The central computer system may also comprise a targeting engine for determining individuals to be targeted for an advertisement for a product. The targeting engine may determine the individual based on: (i) a sensory (e.g., flavor) profile for the product; and (ii) the aggregate sensory profiles for the plurality of individuals generated by the sensory profile aggregation engine. The central computer system may transmit data for the individuals to be targeted for an advertisement for the product to an online ad network so that the advertisement can be shown on web pages visited by the individuals.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary. A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media. Further, the various databases described herein may be implemented using, for example, disk storage systems and/or in-memory databases, such as the SAP HANA in-memory database system.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm,” cloud computing environment, or other grouping of networked servers (such as server blades) that are located and configured for cooperative functions. It can be appreciated that a server farm or cloud computing environment may serve to distribute workload between/among individual components of the farm or cloud, as the case may be, and may expedite computing processes by harnessing the collective and cooperative power of multiple servers. Such server farms or clouds may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A computer-based system for determining an aggregate sensory profile for a plurality of individuals, the system comprising:
a plurality of remote computer systems, wherein each remote computer system comprises:
a local database for storing user data about the plurality of individuals; and
a local sensory profile determination engine for generating local flavor sensory profile data for each of the plurality of individuals based on user data stored in the local database, wherein generating the local flavor sensory profile data comprises computing a value for each of one or more food flavor sensory categories and each of one or more food texture sensory categories, wherein the computed values for the one or more food flavor sensory categories and the one or more food texture sensory categories can assume values in a range of more than two values; and
wherein for at least a first one of the plurality of remote computer systems, the user data comprises active flavor preference data for one or more of the plurality of the individuals, and wherein for at least a second one of the plurality of remote computer systems, the user data comprises passive flavor preference data for one or more of the plurality of individuals; and
a central computer system in communication with the plurality of remote computer systems via a data communication network, wherein the central computer system is for receiving the flavor sensory profile data from the plurality of remote computer systems for the plurality of individuals, and wherein the central computer system comprises:
a central database for storing the flavor sensory profile data received from the remote computer systems; and
a sensory profile aggregation engine for generating aggregate flavor sensory profiles for each of the plurality of individuals by aggregating the flavor sensory profile data for the each individual received from the remote computer systems and stored in the central database, wherein the aggregate flavor sensory profiles for the plurality of individuals are each respectively indicative of each individual's food flavor and texture preferences and each aggregate flavor sensory profile comprises an aggregate value for each of one or more food flavor sensory categories and each of one or more food texture sensory categories, wherein the aggregate values for the one or more food flavor sensory categories and the one or more food texture sensory categories can assume values in a range of more than two values.

2. The system of claim 1, wherein the user data stored in the local databases of the plurality of remote computer systems is secured from the central computer system such that plurality of remote computer systems transmit their local flavor sensory profile data to the central computer system without sending their user data to the central computer system.

3. (canceled)

4. The system of claim 2, wherein there are at least first and second remote computer systems that use passive flavor preference data to generate local flavor sensory profile data for individuals, wherein:
the first remote computer system uses clickstream data of the individuals to generate the local flavor sensory profile data for the individuals; and
the second remote computer system uses purchasing data of the individuals to generate the local flavor sensory profile data for the individuals.

5. The system of claim 4, wherein the active flavor preference data comprises flavor survey data of one or more of the plurality of individuals.

6. The system of claim 1, wherein the central computer system comprises an analytics/insights engine programmed to analyze the aggregate flavor sensory profiles.

7. The system of claim 6, wherein the analytics/insights engine is programmed to generate a composite flavor sensory profile for a geographic region based on the aggregate flavor sensory profiles by combining aggregate flavor sensory profiles for individuals from the geographic region.

8. The system of claim 7, wherein the analytics/insight engine determines an allocation of marketing spend based on the composite flavor sensory profile.

9. The system of claim 7, wherein the composite flavor sensory profile for a geographic region comprises a table, wherein values in cells of the table indicate a percentage of individuals in the geographic region that have and attribute-score pair corresponding to the cell of the table.

10. The system of claim 1, wherein the central computer system comprises a targeting engine for determining individuals to be targeted for an advertisement for a food product based on:
a flavor sensory profile for the food product; and
aggregate flavor sensory profiles for the plurality of individuals generated by the sensory profile aggregation engine.

11. The system of claim 10, wherein the central computer system is for transmitting data for the individuals to be targeted for an advertisement for the product to an online ad network.

12. A computer-implement method for determining an aggregate sensory profile for a plurality of individuals, the method comprising:
receiving, by a central computer system, flavor sensory profile data for each of the plurality of individuals from each of a plurality of remote computer systems, wherein the flavor sensory profile data comprises a value for each of one or more food flavor sensory categories and each of one or more food texture sensory categories, and wherein each of the plurality of remote computer systems generates the sensory profile data for each of the plurality of individuals based on user data stored in a local database of the remote computer systems by computing a value for each of the one or more food flavor sensory categories and the one or more food texture sensory categories, wherein the computed values for the one or more food flavor sensory categories and the one or more food texture sensory categories can assume values in a range of more than two values, wherein:
for at least a first one of the plurality of remote computer systems, the user data comprises active flavor preference data for one or more of the plurality of the individuals; and
for at least a second one of the plurality of remote computer systems, the user data comprises passive flavor preference data for one or more of the plurality of individuals; and
generating, by the central computer system, aggregate flavor sensory profiles for each of the plurality of individuals by aggregating the flavor sensory profile data for each individual received from the plurality of remote computer systems, wherein the aggregate flavor sensory profiles for the plurality of individuals are each respectively indicative of each individual's food flavor and texture preferences, and each aggregate flavor sensory profile comprises an aggregate value for each of one or more food flavor sensory categories and each of one or more food texture sensory categories, wherein the aggregate values for the one or more food flavor sensory categories and the one or more food texture sensory categories can assume values in a range of more than two values.

13. The method of claim 12, wherein the user data stored in the local databases of the plurality of remote computer systems is secured from the central computer system such that plurality of remote computer systems transmit their local flavor sensory profile data to the central computer system without sending their user data to the central computer system.

14. (canceled)

15. The method of claim 13, wherein there are at least first and second remote computer systems that use passive flavor preference data to generate local flavor sensory profile data for individuals, wherein:
the first remote computer system uses clickstream data of the individuals to generate the local flavor sensory profile data for the individuals; and
the second remote computer system uses purchasing data of the individuals to generate the local flavor sensory profile data for the individuals.

16. The method of claim 15, wherein the active flavor preference data comprises flavor survey data of one or more of the plurality of individuals.

17. The method of claim 12, further comprising generating, by the central computer system, a composite flavor sensory profile for a geographic region based on the aggregate flavor sensory profiles by combining aggregate flavor sensory profiles for individuals from the geographic region.

18. The method of claim 17, wherein the composite flavor sensory profile for a geographic region comprises a table, wherein values in cells of the table indicate a percentage of individuals in the geographic region that have an attribute-score pair corresponding to the cell of the table.

19. The method of claim 12, further comprising determining, by the central computer system, individuals to be targeted for an advertisement for a food product based on:
a flavor sensory profile for the food product; and
the aggregate flavor sensory profiles for the plurality of individuals generated by the central computer system.

20. The method of claim 19, further comprising transmitting, by the central computer system, data for the individuals to be targeted for an advertisement for the product to an online ad network.
